(19) United States
(12) Patent Application Publication
(10) Pub. No.: US 2024/0317565 A1
(43) Pub. Date: Sep. 26, 2024

(54) CONTAINER FOR STORING A CORROSIVE LIQUID, APPLICATIONS AND METHOD FOR FILLING

(71) Applicant: Ardagh MP Group Netherlands B.V., AH Deventer (NL)

(72) Inventor: Peter Horz, Kisselbach (DE)

(21) Appl. No.: 16/479,527

(22) PCT Filed: Jan. 22, 2018
(86) PCT No.: PCT/IB2018/050385

§ 371 Date: Dec. 3, 2019

(30) Foreign Application Priority Data
Jan. 20, 2017 (DE) 10 2017 101 149.8
Aug. 1, 2017 (DE) 10 2017 117 447.8

(51) Int. Cl. B67D 1/04; B67D 1/08; B67D 1/12

(52) U.S. Cl. CPC B67D 1/0462; B67D 1/0804; B67D 1/1252; B67D 2001/0822

(57) ABSTRACT

The present invention relates to the technical field of specific packaging technology. The invention aims at providing a comparatively voluminous container suitable for receiving therein corrosive, pasteurized or sterilized beverages, the content of the container being easy to remove by a user. The invention suggests a container comprising a filling space (140), a receiving chamber (109) and a pressure chamber (106). The container comprises a container top (108), a container wall (107), a container base (102) and a pressure chamber base (105). The pressure chamber (106) is formed by the container base (102) and the pressure chamber base (105). The filling space (140) is formed by a bag (120a, 120b) that is fillable with the liquid, and the bag (120a, 120b) is arranged in the receiving chamber (109). The bag (120a, 120b) is fillable with the liquid such that the liquid is in direct contact neither with the container top (108) nor the container wall (107) nor the container base (102).

The present invention relates to the technical field of specific packaging technology. The present invention relates here to a container for receiving and permanently storing therein a pasteurized, sterilized or corrosive beverage, which can easily be removed from the container by a user, the container being comparatively voluminous.

Corrosive beverages, e.g. refreshing drinks (soft drinks) with a low pH value (pH<7), are difficult to store in large packs and could therefore not be stored in a satisfactory manner up to now. Due to their low pH value, the typically metallic wall material of the container is attacked, in spite of possibly provided coatings, (so-called corrosion).

The containers dealt with by the present invention are thus significantly larger than conventional beverage cans (usually 500 ml or 330 ml) and the beverage content should be tappable. In particular the container dealt with holds here more than 1.5 L, especially more than 2.5 L, of one of the above-mentioned problematic beverages and/or specifically less than 51 L or less than 21 L (for packs with 20,000 ml or 50,000 ml content).

A consumer will find it particularly convenient to remove a beverage from a container via a tap.

Portable beer barrels are known for the tapping of beer, these beer barrels being relevant especially in two variants.

One variant of such portable beer barrels provided with a metallic jacket can be emptied by the effect of gravitational force. A tap is arranged in the lower area of the outer side of the container. By opening the tap, the beer can flow out. In order to prevent the generation of negative pressure in the container, such containers comprise a device that allows air from the surroundings to enter the interior of the container. Such containers are not very user-friendly, since for the purpose of filling a glass with beer, the barrel must be placed e.g. at the edge of a table or the barrel must be provided with a substructure so that the glass can be filled below the tap. In addition, the keeping quality of the barrel contents will be reduced substantially after opening of the barrel through atmospheric oxygen flowing in when the beer flows out.

Another variant consists of containers that include an internal pressure system. These systems keep the pressure inside above the ambient pressure. This allows the tap to be arranged in the upper area of the tank. Thus, a consumer typically has sufficient space between the lower discharge end of the tap and the placement level of the container to hold a glass to be filled under the tap, without specific positioning of the barrel being necessary. Through the use of internal pressure systems, the beer can be kept up to more than 30 days after the barrel has been opened, since no atmospheric oxygen will flow into the barrel while beer is removed from the latter.

A beer barrel system of the second variant is accessible to the person skilled in the art from WO 1999/47451 (Heineken Technical Services). There a beer barrel system is described, which comprises a pressure cartridge that is arranged in the interior of the container space filled with beer and generates an overpressure in this space. The pressure cartridge comprises activated carbon, which means that, in comparison with a cartridge having no activated carbon provided therein, a larger amount of compressed gas or propellant gas can be introduced into the cartridge, without causing an excessive increase in pressure in the cartridge.

Such containers (beer barrels) are unsuitable, in particular for corrosive, pasteurized or sterilized beverages.

Pasteurization or sterilization conditions inside the container cannot adequately be guaranteed over a prolonged period of time or the pasteurization or sterilization conditions get lost during tapping of the beverage. An example of pasteurized or sterilized beverages to be stored are fruit juices.

Even corrosive beverages, such as refreshing drinks (soft drinks) with a low pH value (pH<7), cannot be stored satisfactorily in the containers known. Due to the low pH value, the typically metallic wall material may be attacked (corrosion) through minor defects of the wall material of the container. The wall material of the container may also be attacked, if the pH value of the contents is high (pH>7). Normal anticorrosive coatings provided on the inner surfaces of the container, which come into contact with the liquid, and used to avoid e.g. rust formation or other types of corrosion are often unsuitable for the purpose of preventing corrosion caused by acidic liquids (pH value less than 7) or basic liquids (pH value greater than 7).

The present invention has to solve the task of providing a comparatively voluminous container, which is suitable for accommodating corrosive, pasteurized or sterilized beverages and which allows the content of the container to be easily removed by a consumer.

This task is solved by a container according to claim 1 or according to claim 18, which are adapted for use according to claim 20 and according to claim 21, and by a method for filling a container with a liquid according to claim 22.

A container for storing a liquid comprises a filling space, a receiving chamber and a pressure chamber. The container comprises a container top, a container wall, a container base and a pressure chamber base. The pressure chamber is formed by the container base and the pressure chamber base. The filling space is formed by a bag that is fillable with the liquid. The bag is arranged in the receiving chamber. The bag is fillable with the liquid such that the liquid is in direct contact neither with the container top nor the container wall nor the container base (claim 1).

Due to the fact that the liquid is in direct contact neither with the container top nor the container wall nor the container base, it is ensured that not even a corrosive or aggressive liquid will corrode or attack the container parts described. In addition, sensitive liquids, such as pasteurized or sterilized beverages, can safely be stored in the container, since the liquid will neither enter into contact with the container parts described nor will it be influenced by the atmosphere in the receiving chamber (e.g. atmospheric oxygen).

The pressure chamber provides an overpressure. By connecting the pressure chamber with the receiving chamber, e.g. by means of a valve, the pressure in the receiving chamber may be controlled. The pressure in the receiving chamber may thereby be transmitted to the filling space.

Preferably, a valve, which, in the open condition of the valve, connects the receiving chamber and the pressure chamber in a fluid-communicating manner, is connected both to the container base and to the pressure chamber base. Due to the connection of the valve with the container base and the pressure chamber base, at least part of the force acting on the container base and the pressure chamber base as a result of the pressure difference between the pressure chamber and the receiving chamber and the pressure chamber and the surroundings of the container can be absorbed.

Such a valve (pressure valve or pressure control valve) is to be understood as a valve assembly from the functional point of view and comprises, in addition to a shut-off unit, further components that are closely related to the “pressure valve” function.

The shut-off unit is the component of the valve (valve assembly) which, when closed, sealingly separates spaces with different pressure levels. An example for a shut-off unit in such a valve is a disk-type shut-off unit comprising typically a sealing disk and a disk seat. When the sealing disk is pressed onto the disk seat, two spaces (e.g. above the sealing disk and below the sealing disk) with different pressure levels are shut off from each other, so that the different pressure levels of the spaces are maintained for at least a prolonged period of time, if no other influences act on the spaces with the different pressure levels. When the sealing disk is moved away from the disk seat, the spaces with different pressure levels will be in fluid communication and pressure compensation between the spaces can take place. Typically, pressure compensation takes place by a flow of a fluid in the space under higher pressure into the space under lower pressure. This flow takes place until a condition is reached, e.g. a pressure threshold value in one of the two communicating spaces, and the sealing disk is again pressed onto the disk seat, so that the spaces are separated from each other in a fluid-tight manner.

A valve within the meaning of the present invention comprises, in addition to the shut-off unit described, e.g. a valve body, a valve housing, one or a plurality of channels, fluid guide elements and/or fluid connection elements.

Components that functionally serve the valve function between the two spaces belong to the valve (pressure valve or pressure control vale valve).

One of the functions of the valve is conducting and guiding a fluid from a space under higher pressure into another space under lower pressure, in the open condition of the valve. If the valve is closed, the spaces referred to are not connected in a fluid-communicating or pressure-communicating manner. The spaces are here the spaces in which a fluid under increased pressure is stored primarily (e.g. pressure chamber) and a fluid under lower pressure is effective (it acts in the filling space, by way of example), also the lower pressure being typically higher than the ambient pressure.

The fluid under lower pressure is effective e.g. insofar as it causes a pressure in the filling space (and also in the receiving chamber) that is higher than the ambient pressure, thus allowing a consumer to remove a liquid from the filling space by opening a valve provided on the container (e.g. on the top of the container), since due to the pressure in the filling space—which is higher than the ambient pressure—a discharge of the content is caused by opening the valve provided on the container.

The pressure chamber is preferably filled with a propellant gas, the propellant gas used being carbon dioxide (CO₂), nitrogen (N₂), nitrous oxide (N₂O) or mixtures of these gases. The propellant gas may also comprise an inert gas, the proportion of inert gas being higher than the proportion in the surroundings of the container. A gas is here inert if, under normal storage and tapping conditions (typically in a range of absolute pressure between 0.5 bar and 10 bar and a temperature range between 0° C. and 50° C.), a liquid to be stored in a container disclosed does not, or only insignificantly react with the inert gas and the gas is stable. In particular, the inert gas may be nitrogen, a noble gas (helium, neon, argon, krypton, xenon, radon) or mixtures thereof. Argon is particularly preferred.

The pressure in the pressure chamber may be between 5 bar (0.5 MPa) and 35 bar (3.5 MPa), preferably between 5 bar and 30 bar, particularly preferred between 8 bar and 25 bar.

In general, the disclosed values of pressure refer, unless otherwise specified, to the relative pressure, the ambient pressure being the reference value.

The pressure chamber preferably has a volume between 0.1 L and 5 L, particularly preferred between 0.1 L and 3 L, even more preferred between 0.5 L and 2.5 L, most preferred between 0.5 L and 1.5 L. The pressure chamber may also have a volume between 0.4 L and 0.7 L.

Preferably, the pressure chamber is not provided with a filler.

A filler is a component that typically exists in a solid physical state under environmental conditions and that allows to accommodate a certain amount of a substance. The increase in pressure caused by introducing the substance will be lower in the space, in which the filler has been inserted, in comparison with the introduction of the same amount of a substance into the same space containing no filler. Examples of a filler are activated carbon or zeolites.

The vapor pressure of the propellant gas or of the propellant gas mixture may be higher than the pressure in the pressure chamber, preferably down to a temperature of −5° C.

The receiving chamber may be formed by the container top, the container wall and the container base (claim 2).

The container may comprise an opening at the container top, the opening being closed by a closure (claim 3).

The bag may be secured to the closure. In particular, an upper end of the bag is glued to the closure, welded thereto or secured thereto via an airtight clamp (claim 4).

Due to the fact that the bag is secured to the closure, which is positioned in an opening or on an opening of the container top, it can be ensured that a liquid stored in the bag will come into contact with the smallest possible number of container components.

As described above, the container may comprise a pressure valve.

The pressure valve may be connected to the container base and the pressure chamber base (claim 5).

When seen under the aspect of function, the pressure valve comprises a shut-off unit. The shut-off unit may be arranged in the pressure valve such that the shut-off unit is arranged, at least sectionwise, in the pressure chamber. Preferably, the shut-off unit is arranged completely within the pressure chamber (claim 6), but is surrounded by a valve body, which is also arranged within the volume of the pressure chamber.

The shut-off unit may also be arranged in the pressure valve such that the shut-off unit is, at least sectionwise, arranged outside the pressure chamber. Preferably, the shut-off unit is arranged completely outside the pressure chamber (claim 7).

The pressure chamber base may have an opening, which allows a pressurized fluid in the pressure chamber to enter the pressure valve via the at least one opening in the pressure chamber base (by passing through the opening) and to flow through the pressure valve (claim 8).

The bag in the container may be flexible.

Flexible means that the bag is pliable and deformable, when a human of average physical strength applies a force thereto.

The bag may be expandable and preferably comprise an elastomer.

Expandable means that the surface of the bag can be enlarged by the application of a force, without the bag being damaged or torn, whereby the possibility of storing a liquid therein would be impaired. If the bag contains an elastomer, the bag may have elastic properties, so that it will be deformable under the action of a force, but return to the shape it had before the force was applied, when the force has ceased.

The bag may comprise at least one plastic layer, in particular polypropylene (PP). Specifically, the bag comprises at least one plastic layer and at least one aluminum layer. Preferably, the bag comprises a plasma-coated plastic layer, the plastic layer being especially plasma-coated with aluminum (claim 9).

In the unfilled condition, the bag may be folded or rolled (claim 10).

When the bag is folded or rolled, the bag can, in comparison with a non-folded or non-rolled bag, be introduced in the container through a smaller opening in the container. By filling the bag, the bag can unfold or unroll.

The receiving chamber may have a volume of more than 1.5 L, in particular more than 2 L, preferably at least 5 L, particularly preferred between 2 L and 30 L, even more preferred between 5 L and 20 L (claim 11).

Since the bag is located in the receiving chamber, the volume of the bag can only be smaller than or equal to the volume of the receiving chamber, the volume of the liquid that can be accommodated being thus limited as well.

The bag may have a volume of more than 1.5 L, in particular 2 L, preferably at least 5 L, particularly preferred between 2 L and 30 L, even more preferred between 5 L and 20 L (claim 12).

By means of a discharge line provided with a valve, the bag and a space surrounding the outlet of the discharge line may be connected in a fluid-communicating manner, when the valve is open (claim 13).

Via the discharge line, a consumer can discharge the liquid in the container by actuating the valve.

The closure may have connected thereto a discharge line, so that the discharge line is connected in a fluid-communicable manner to a filling space line, the filling space line extending preferably down to the bottom of the bag (claim 14).

A filling space line that extends into the bag containing the liquid can improve the removal of the liquid or minimize the amount of liquid that will remain in the bag although the valve of the discharge line is open.

The filling space line may have provided thereon a device at the lower end thereof (bottom of the bag), in particular if the filling space line extends right down to the bottom of the bag, the device preventing the bag from being sucked onto or pressed against the opening of the filling space line and from closing the same. Such a device may e.g. be a head comprising a lattice structure or ribs.

The closure, which is arranged in or on the opening of the container, may comprise a first valve and a second valve (claim 15).

Preferably, the first valve comprises a first channel, wherein, in the open condition of the first valve, the first channel connects in a fluid-communicating manner the bag and a space surrounding the container (claim 16).

The second valve may comprise a second channel, wherein, in the open condition of the second valve, the second channel connects in a fluid-communicating manner the receiving chamber and a space surrounding the container (claim 17).

A further container for storing a liquid comprises a filling space, a receiving chamber and a pressure chamber. The container comprises a container top, a container wall, a container base and a pressure chamber base. The pressure chamber is formed by the container base and the pressure chamber base. The filling space is formed by a bag that is fillable with the liquid, and the bag is arranged in the receiving chamber. An upper end of the bag is associated with an opening in the container top for filling the bag with the liquid (claim 18).

Such a container may have the above described features (claim 19).

The containers disclosed can be used for storing a beverage having a pH value of less than 7, in particular less than 5, especially less than 4 (claim 20).

Beverages having a low pH value may attack and corrode the typically metallic surface of a container of the type described here. As a result, the container may fail in its capacity as a storage device.

The containers described may also be used for storing a pasteurized or sterilized beverage (claim 21).

Sterilized or pasteurized beverages are particularly sensitive to external influences, such as contact with a metallic surface or contact with oxygen, whereby the pasteurization or sterilization condition may get lost during storage.

A container can be filled with a liquid according to a method. The container comprises a filling space and a receiving chamber. The filling space is formed by a bag and the bag is arranged in the receiving chamber. The method comprises the steps of providing the container and filling the bag with the liquid, the filling being carried out such that an increase in volume of the bag during filling will be made up for or compensated for by a flow of content from the receiving chamber into the surroundings of the container, substantially without an increase in pressure in the receiving chamber (claim 23).

Within the method, any disclosed container may be used.

“Substantially without an increase in pressure in the receiving chamber” relates to the fact that, when the bag has been filled (increase in volume of the bag), the pressure in the receiving chamber will substantially not be higher than the pressure in the receiving chamber before the bag has been filled with the liquid. The “substantially” corresponds to a pressure difference of not more than 30%, preferably not more than 20%, particularly preferred not more than 10%.

According to the present method, the container may comprise an opening that is closed by a closure (claim 24).

The closure may comprise a first valve with a first channel through which the bag is filled with the liquid (claim 25).

In such an embodiment, the closure may not yet tightly close the opening of the container, so that a content in the receiving chamber, e.g. air, will flow past the closure into a space surrounding the container, while the bag is being filled and its volume increases or the volume enlarges.

When the bag has been filled, the opening of the container can be closed by the closure (claim 26).

Once the opening of the container has been closed, no further content of the receiving chamber can escape from the container, nor is this necessary, since, in the filled condition of the bag, the bag has its maximum volume.

The closure may comprise a first valve with a first channel, the bag being filled with the liquid via the first channel. The closure may comprise a second valve with a second channel, at least part of the content of the receiving chamber flowing via the second channel into the surroundings of the container during the filling process of the bag (claim 27).

On the basis of such a structural design of the closure, an increase in pressure in the receiving chamber due to an expansion of the bag during the filling process is avoided by a discharge of e.g. air from the receiving chamber via the second channel of the second valve.

The opening of the container may be closed by the closure before the bag is filled (claim 28).

This is made possible by the structural design of the closure comprising two valves and two channels.

A container can also be filled with a liquid according to the method following now. In the case of this method, the container comprises a filling space and a receiving chamber. The filling space is formed by a bag and the bag is arranged in the receiving chamber. The bag comprises an opening that is closed by a closure. The closure comprises a first valve and a second valve. The second valve connects the receiving chamber and a pressure controller. The method comprises the steps of providing the container and filling the bag with the liquid via the first valve of the closure, an increase in volume of the bag taking place during the filling process. The pressure controller connected to the receiving chamber via the second valve allows an increase in pressure due to expansion of the bag during the filling process up to a threshold value (claim 29).

If the pressure in the receiving chamber rises to a value above the threshold value, the pressure controller will open and connect the receiving chamber to the surroundings of the container until the pressure in the receiving chamber returns to or drops below the threshold value.

Within the method, each of the disclosed containers may be used.

Such a method, in which an increased pressure on the bag builds up in the receiving chamber by an expansion of the bag, is particularly suitable for foaming liquids, e.g. for beverages charged with carbon dioxide.

Foaming liquids are liquids that are capable of foaming. Foaming can be caused e.g. by a change in pressure or temperature or by an impulse, which releases a gas dissolved in the liquid and causes a formation of foam.

Due to the counterpressure, excessive foaming of a foaming liquid can be prevented or reduced, whereby the process of filling a container with a foaming liquid will be facilitated.

The threshold value of the pressure controller may lie between 0.1 bar and 8 bar. Preferably, the threshold value lies between 0.5 bar and 7 bar, particularly preferred between 1 bar and 5 bar, even more preferred between 2 bar and 4.5 bar (claim 30).

The pressure controller may be connected via the second valve to the receiving chamber during filling of the bag (claim 31).

The embodiments of the present inventions are illustrated by means of examples and not disclosed in a manner that transfers or reads restrictions from the figures into the claims. These examples are to be read and considered as examples even in the event that “by way of example”, “in particular” or “e.g.” is not used everywhere and in every place. Nor should the description of an embodiment be read such that there is no other embodiment or that other possibilities are excluded, if only one example is presented. These provisos should be read into the entire description following hereinafter.

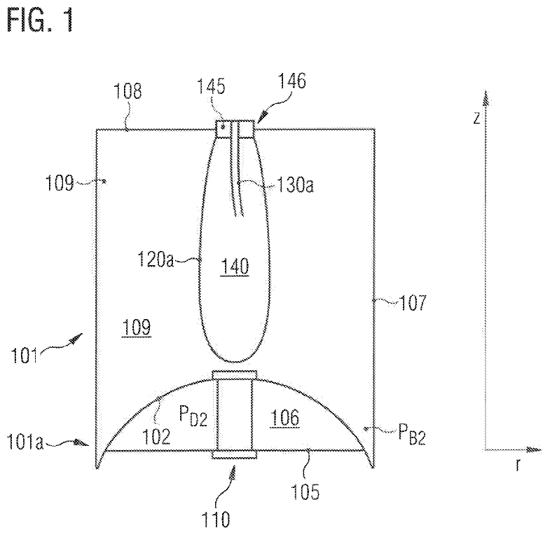

FIG. 1 shows an embodiment of a container 101, not filled with a beverage, with a bag 120a.

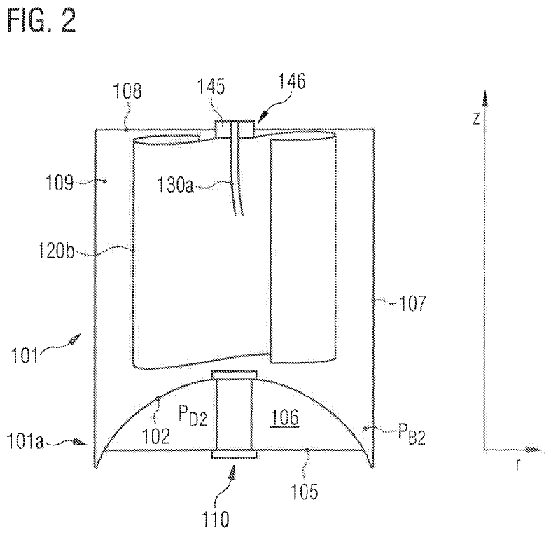

FIG. 2 shows a further embodiment of a container 101, not filled with a beverage, with a bag 120a.

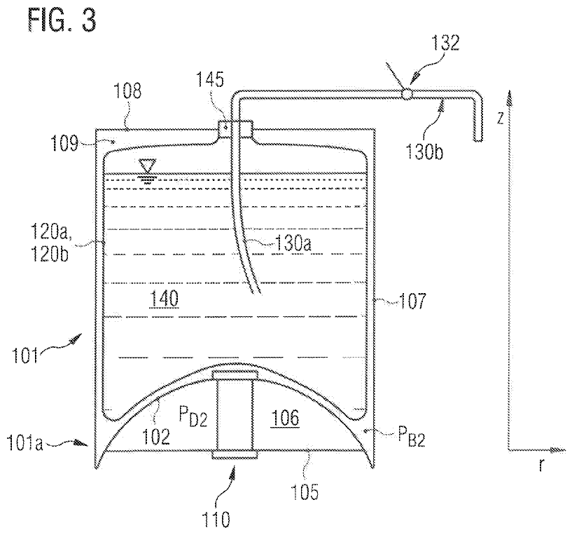

FIG. 3 shows a container 101 filled with a beverage.

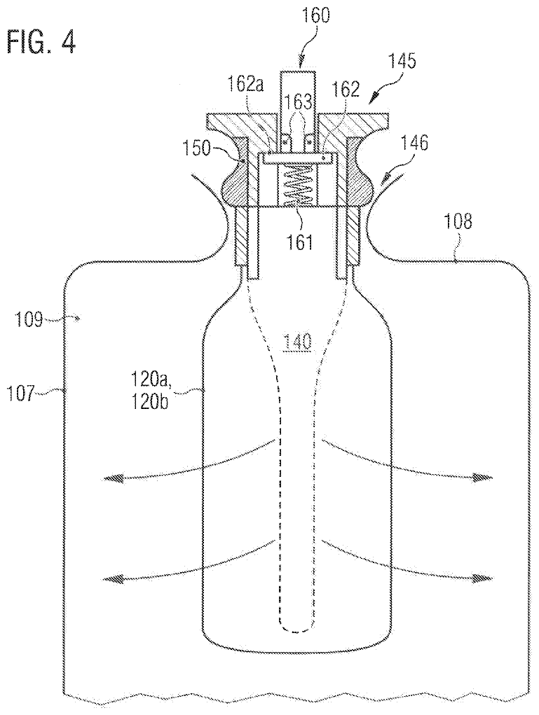

FIG. 4 shows a detailed view of an embodiment of a closure 145 of an unfilled container 101.

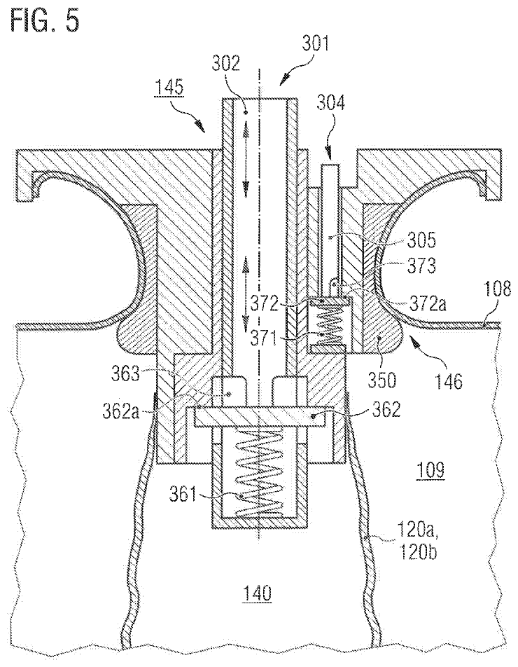

FIG. 5 shows a detailed view of a further embodiment of a closure 145 of an unfilled container 101.

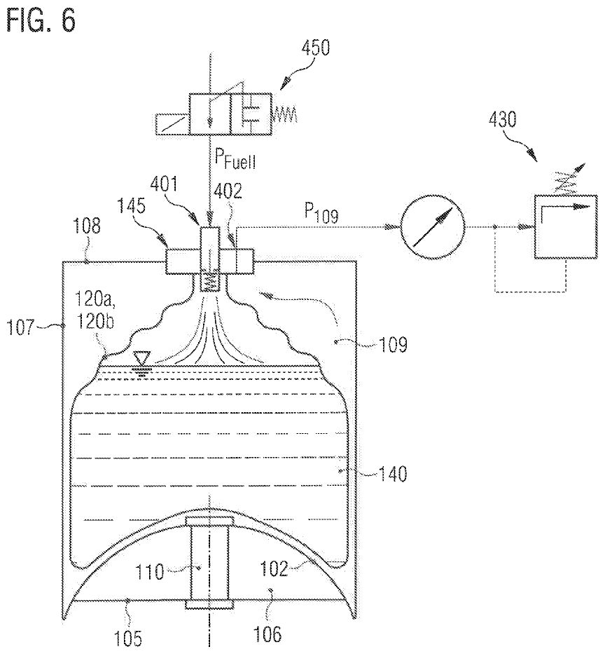

FIG. 6 shows filling of a container 101 with a pressure controller 430.

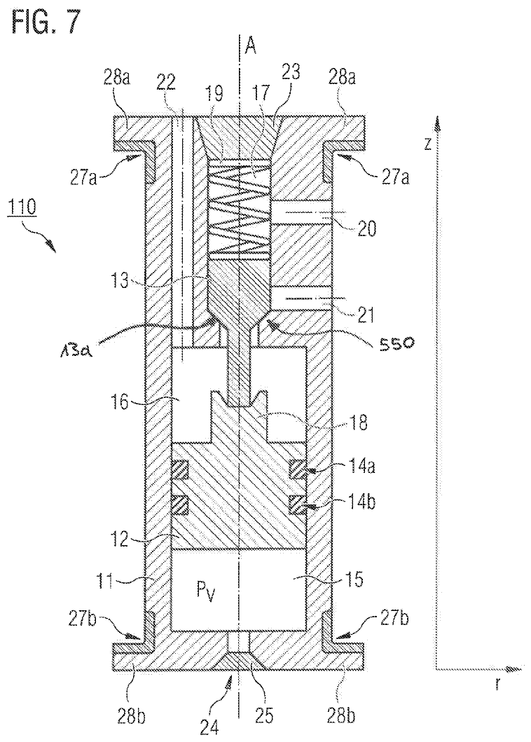

FIG. 7 shows, in a sectional view in the z-direction, a pressure valve 110 that is adapted to be installed on the base side, the first piston 12 and the second piston 13 being coupled. The shut-off unit 550 is defined by the piston 13 and the valve seat 13a.

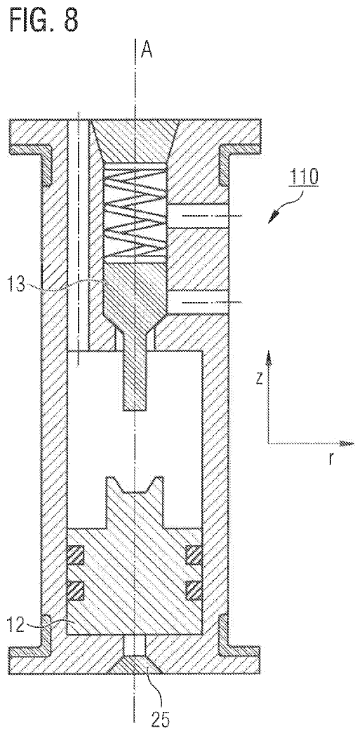

FIG. 8 shows, in a sectional view in the z-direction, a pressure valve 110 that is adapted to be installed on the base side, the first piston 12 and the second piston 13 being not coupled.

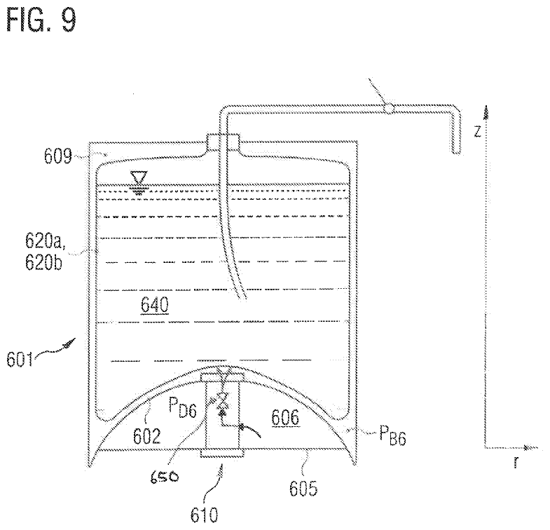

FIG. 9 shows a container 601 with a pressure valve 610 connected to a container base 602 and a pressure chamber base 605. The container base 602 corresponds to the container base 102 and the pressure chamber base 605 corresponds to the pressure chamber base 105.

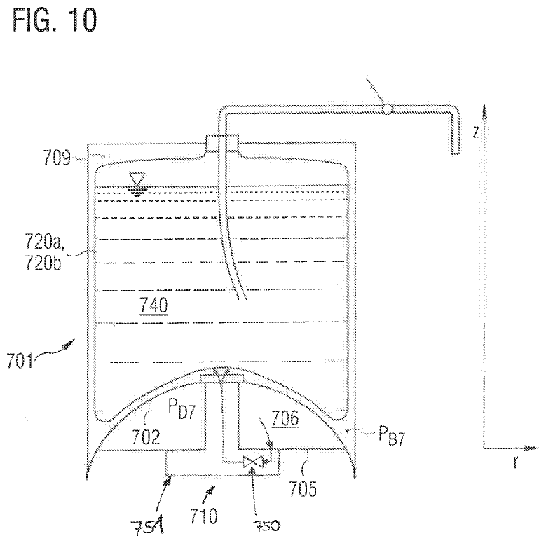

FIG. 10 shows a container 701 with a pressure valve 710 connected to a container base 702 and a pressure chamber base 705. The container base 702 corresponds to the container base 102 and the pressure chamber base 705 corresponds to the pressure chamber base 105.

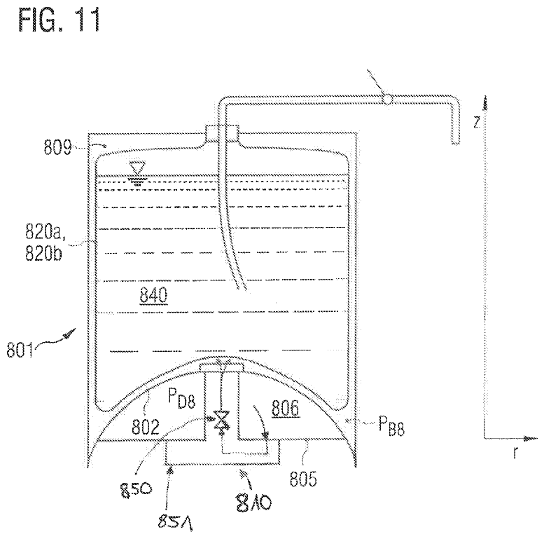

FIG. 11 shows a container 801 with a pressure valve 810 connected to a container base 802 and a pressure chamber base 805. The container base 802 corresponds to the container base 102 and the pressure chamber base 805 corresponds to the pressure chamber base 105.

FIG. 1 shows an embodiment of a container 101. The container comprises a receiving chamber 109, a filling space 140 and a pressure chamber 106. The container comprises a container top 108, a container wall 107, a container base 102 and a pressure chamber base 105.

The pressure chamber 106 is formed by the container base 102 and the pressure chamber base 105. In the pressure chamber 106 a pressure p_{D2} prevails, in the receiving chamber 109 a pressure p_{B2} prevails.

The pressure p_{D2} in the pressure chamber 106 is typically higher than the pressure p_{B2} in the receiving chamber 109.

The filling space 140 is formed by an expandable bag 120a and is shown in FIG. 1 in an unfilled state. The bag 120a is attached to a closure 145, the closure 145 closing an opening 146 in the container top 108 of the container 101.

A line 130a to the filling space 140 projects from the closure 145 into the filling space 140 (which is formed by the expandable bag 120a).

When the bag 120a is filled, e.g. via the closure 145, the bag 120a will expand until the bag 120a occupies most of the receiving chamber 109. As a result, most of the volume of the receiving chamber 109 is filled by a liquid in the filling space 140, but the liquid contacts neither the container top 108 nor the container wall 107 nor the container base 102.

The pressure chamber 106 is arranged in the container base area 101a.

A further embodiment of a container 101 is shown in FIG. 2. The container 101 comprises a receiving chamber 109, a pressure chamber 106 and a filling space 140. The container 101 comprises a container top 108, a container wall 107, a container base 102 and a pressure chamber base 105.

In the pressure chamber 106 a pressure p_{D2} prevails and in the receiving chamber 109 a pressure p_{B2} prevails. The pressure chamber 106 is connected to the receiving chamber 109 via a pressure valve 110. When the pressure valve 110 is open, there is fluid communication between the pressure chamber 106 and the receiving chamber 109. When the pressure valve 110 is closed, the pressure chamber 106 and the receiving chamber 109 are separated from each other in a fluid-tight manner. The pressure chamber 106 is arranged in the container base area 101a. This also applies to the container in FIG. 1.

A closure 145 closes an opening 146 in the container top 108 of the container 101. This closure 145 has arranged thereon a filling space line 130a and a folded plastic layer bag 120b.

In the embodiment of the container 101 shown in FIG. 2, the bag 120b is much less expandable than the bag 120a according to FIG. 1. When the bag 120b is filled with a liquid, the bag 120b unfolds, so that most of the receiving chamber 109 will be occupied by the bag 120b, the liquid contacting also in this case neither the container top 108 nor the container wall 107 nor the container base 102 directly.

FIG. 3 shows a container 101 that is filled with a liquid. The liquid is contained in the filling space 140, which is formed by a bag 120a, 120b.

In addition to the representations in FIG. 1 and FIG. 2, FIG. 3 shows a discharge line 130b connected to the filling space line 130a at the closure 145.

The pressure p_{D2} in the pressure chamber 106 is above the pressure p_{B2} in the receiving chamber 109, which, in turn, is above the ambient pressure. Due to pressure communication between the filling space 140 and the receiving chamber 109, the pressure prevailing in the filling space 140 corresponds essentially (deviation less than 20%) to the pressure in the receiving chamber 109 (pressure p_{B2}). When a consumer opens a valve 132 on the discharge line 130b, a certain amount of the liquid in the filling space 140 will flow out of the discharge line 130b. According to the volume removed, the pressure p_{B2} in the receiving chamber 109 decreases. If the pressure falls below a threshold value, the pressure valve 110 will open and a gas will flow out of the pressure chamber 106 (while the pressure p_{D2} in the pressure chamber 106 decreases) and into the receiving chamber 109, thus causing an increase in the pressure p_{B2} in the receiving chamber 109. If a further threshold value is exceeded, the pressure valve 110 will close so that there will be no further fluid communication between the pressure chamber 106 and the receiving chamber 109.

A detailed representation of a closure 145 is shown in FIG. 4. For filling the filling space 140, formed by a bag 120a, 120b, a pre-assembled closure-bag unit can be inserted through the opening 146 into the container top 108 of the container 101. The closure 145 with the bag 120a, 120b is here inserted into the opening 146 in such a way that the opening 146 is not closed. In this condition, the filling space 140 can be filled, whereby an increase in volume of the bag 120a, 120b takes place and part of the content (e.g. air) of the receiving chamber 109 is displaced and can escape via the not fully closed opening 146. When the filling space 140 is completely filled, the closure is pressed into the opening 146 such that the opening 146 is closed. A sealing element 150 of the closure 145 can then be in sealing contact with the opening 146.

Filling of the filling chamber 140 is carried out via a line 160 of the closure 145. If no additional force is applied, a valve disk 162 will sealingly abut on a counter-contour 162a of the closure 145 and is pretensioned by a tensioning element 161. If a force is applied on the valve disk 162 in the negative z-direction, e.g. via the line 160, the valve disk 162 will move in the negative z-direction, so that a liquid can flow through the line 160 into the interior of the filling space 140 via openings 163 in the line 160.

A detailed representation of a closure 145 according to another embodiment is shown in FIG. 5. The closure 145 comprises here a first valve 301 with a first channel 302 and a second valve 304 with a second channel 305. In contrast to the embodiment shown in FIG. 4, the closure 145 is here already arranged in the opening 146 in a sealingly closing manner before the filling space 140 is filled. The first valve 301 is closed, if no additional force is applied, by a valve disk 362 abutting on a counter-contour 362a of the closure 145, the valve disk 362 being pretensioned by a tensioning element 361.

For filling the filling space 140, a force is applied to the first valve 301, so that the latter will move in the negative z-direction and a liquid will be able to flow through the first channel 302 via openings 363 into the filling space 140. When the liquid enters the filling space 140, the bag 120a, 120b will expand in the receiving chamber 109. An increase in pressure in the receiving chamber 109 is prevented by the second valve 304. If no further force is applied, the second valve 304 is closed by a valve disk 372 abutting on a counter-contour 372a, the valve disk 372 being pretensioned by a tensioning element 371.

If a force is applied in the negative z-direction to the second valve 304, the latter will move in the negative z-direction, so that the second channel 305 of the second valve 304 will be in fluid communication with the receiving chamber 109 via openings 373. By opening the second valve 304 during the filling process of space 140, an increase in pressure in the receiving chamber 109 can be prevented in a suitable manner.

When the filling process of the container 101 has been completed, the second valve 304 is preferably acted upon such that it will no longer be operative. Alternatively, the second valve 304 may be configured such that the second valve 304 cannot be operated without auxiliary means or a tool. These measures serve to avoid or make it more difficult to manipulate the container 101 in its filled condition.

FIG. 6 shows a container 101, which is filled with a liquid. The container 101 comprises a pressure chamber 106 formed between a container base 102 and a pressure chamber base 105. The pressure chamber 106 has arranged therein a pressure valve or a valve arrangement 110. The pressure valve 110 contacts the upper side of the container base 102 and the lower side of the pressure chamber base 105. The container base 102 is dome-shaped.

A receiving chamber 109 is formed by a container top 108, a container wall 107 and the container base 102. An opening in the container top 108 is closed by a closure 145.

The receiving chamber 109 has arranged therein a bag 120a, 120b, through which or in the interior of which a filling space 140 is formed.

The closure 145 comprises a first valve 401 and a second valve 402. Via the first valve 401, a liquid, typically a liquid under overpressure, can be introduced into the filling space 140 formed in the bag 120a, 120b. For controlling the pressure of the filling, a filling valve 450 controls the filling pressure P_{Fuell} of the liquid to be filled in, and is arranged upstream of the closure 145.

As the volume of the liquid filled into the filling space 140 via the first valve 401 increases, the volume of the filling space 140 enlarges by corresponding expansion of the bag 120a, 120b. Due to the increasing volume of the filling space 140, the volume of the receiving chamber 109 will be reduced in size, whereby the pressure P₁₀₉ in the receiving chamber 109 will increase (without an exchange of substances of the content in the receiving chamber 109).

The second valve 402 of the closure 145 connects the receiving chamber 109 with a pressure controller or regulating valve 430. If, due to the progressive expansion of the bag 120a, 120b, the pressure rises above a threshold value that can be set at the pressure controller 430, the pressure controller 430 will open, so that the receiving chamber 109 will be open to the surroundings of the container 101. Due to such opening of the pressure controller 430, the pressure P₁₀₉ in the receiving chamber 109 will decrease. If the pressure P₁₀₉ in the receiving chamber 109 reaches or falls below the threshold value specified at the pressure controller 430, the pressure controller 430 will close, so that no further content of the receiving chamber 109 will be discharged into the surroundings of the container 101. The second valve 402 may, with the same function, also be arranged outside the closure 145, for example in or on the container top 108 or the container wall 107.

Thus, after an initial phase of filling, during which a pressure above the ambient pressure builds up in the receiving chamber 109, an increased pressure prevails in the receiving chamber 109, which acts on the bag 120a, 120b and thus on the filling space 140. This especially allows to prevent or reduce a foaming of a foaming liquid during a filling process.

FIGS. 7 and 8 show pressure valves 110 in different states, which can be used in all the containers disclosed.

FIG. 7 shows, in a sectional view in the z-direction, an embodiment of a pressure valve 110, which can be installed in a container 101 on the base side, as described above. The pressure valve 110 comprises a first pressure valve chamber 15 in which a pressure p_{V} prevails. The first pressure valve chamber 15 is delimited by a pressure valve body 11 and a first piston 12. The pressure valve body 11 has arranged therein a pressure valve inlet 24, through which the first pressure valve chamber 15 can be filled with a gas. The pressure valve inlet 24 is adapted to be closed in a fluid-tight manner by a cover 25. Furthermore, the pressure valve comprises a second pressure valve chamber 16 that is delimited by the pressure valve body 11, the first piston 12 and a second piston 13. The second pressure valve chamber 16 is connected via a receiving-chamber channel 22 with a space in a fluid-communicating manner, the space being located outside the pressure valve 110. This space is the receiving chamber 109, when the pressure valve 110 has been installed in a container. The pressure valve 110 additionally comprises a third pressure valve chamber 17, which is delimited by the second piston 13 and the pressure valve body 11. The third pressure valve chamber 17 is connected via a first pressure-chamber channel 20 with a space in a fluid-communicating manner, the space being located outside the pressure valve 110. This space is the pressure chamber 106, when the pressure valve 110 has been installed in a container base.

In the third pressure valve chamber 17, a tensioning element 19 is fixed in position between the pressure valve body 11 and the second piston 13. In this embodiment, the tensioning element 19 is a spring. The tensioning element 19 holds a conical section of the second piston 13 in a counter-structure 13a formed in the pressure valve body 11 and acting as a seat, so that the conical section of the second piston 13 acts as a conical seat valve. In this condition, in which the conical section of the second piston 13 is in sealing contact with the counter-structure 13a of the pressure valve body 11, the pressure valve 110 is closed. In the closed condition of the pressure valve 110, the space lying outside the receiving-chamber channel 22 is separated in a fluid-tight manner from the space lying outside the first pressure-chamber channel 20. The conical section of the piston 13 and its counter-structure 13a constitute the shut-off unit 550, which can be considered to comprise also the second piston 13 in its entirety.

The upper and the lower end of the pressure valve 110 have each arranged thereon a projection 28a, 28b. The projections 28a, 28b project radially (r-direction) beyond the radial dimensions of the pressure valve body 11. These projections 28a, 28b provide an improved seating of the pressure valve 110, when the pressure valve 110 is inserted into the openings 2a, 5a of the container base 102 and of the pressure chamber base 105 (cf. FIGS. 2 and 3). Sealing elements 27a, 27b are arranged on the respective sides of the projections 28a, 28b pointing towards the center of the pressure valve and on a respective axial section of the pressure valve body 11. When the pressure valve 110 is inserted into openings of the container base 102 and of the pressure chamber base 105, the sealing elements 27a, 27b abut on the respective upper side of the container base 102 and on the respective lower side of the pressure chamber base 105. This will guarantee a better seal tightness.

The first piston 12 has arranged thereon two seals 14a, 14b. In this embodiment, the seals 14a, 14b are configured as O-rings. Likewise, the seals 14a, 14b can be realized as (direct) injection molded seals. The seals 14a, 14b separate the first pressure valve chamber 15 and the second pressure valve chamber 16 from each other more effectively in a fluid-tight manner and cause most of the frictional force during a movement of the first piston 12.

In the condition of a pressure valve 110 shown in FIG. 7, a gas has been introduced in the first pressure valve chamber 15, so that a sufficiently high pressure p_{V} prevails in the first pressure valve chamber 15 for overcoming the frictional force between the first piston 12 or seals 14a, 14b and the pressure valve body 11 as well as the gravitational force. As a result, the first piston 12 has moved in the positive z-direction until the reception element 18 contacts the end face of the second piston 13.

There is an equilibrium of forces in the pressure valve 110. A force acts on the first piston 12 in the positive z-direction, which results from the pressure p_{V} in the first pressure valve chamber 15 in connection with the area of the first piston 12 to which the pressure p_{V} is applied. In addition, a force acts in the positive z-direction, which results from the pressure in the space outside the receiving-chamber channel 22 that is applied to the conical section of the second piston 13 as an axially acting pressure. In the negative z-direction, a force acts on the first piston 12, which results from the pressure outside the receiving-chamber channel 22 that is applied to the end face of the first piston 12. In addition, a force applied by the tensioning element 19 to the second piston 13 as well as the gravitational forces of the first and second pistons 12, 13 act in the negative z-direction. A further force acting in the negative z-direction is a force resulting from the pressure outside the first pressure-chamber channel 20, as far as the pressure is applied to the upper end face of the second piston 13.

When the pressure valve 110 is installed in the container base of a container 101, as shown e.g. in FIGS. 1 to 3, the pressure outside the receiving-chamber channel 22 corresponds to the pressure of the receiving chamber 109 and the pressure outside the first pressure-chamber channel 20 corresponds to the pressure of the pressure chamber 106. If the pressure in the receiving chamber 109 decreases due to the fact that a volume of liquid is removed from the bag 120a, 120b, the equilibrium of forces may be changed. If the decrease in pressure is sufficiently large, the first and second pistons (coupling) will move in the positive z-direction and the pressure valve 110 is open. In the open condition of the pressure valve 110, an exchange of fluid takes place via the second pressure-chamber channel 21 until the force acting on the first piston 12 in the negative z-direction is sufficiently strong to displace the first and second pistons 12, 13 in the negative z-direction until the pressure valve 110 is in the closed condition. The frictional force between the first piston or seals 14a, 14b and the pressure valve body 11 will here act in the positive as well as in the negative z-direction, depending on the direction of movement of the first piston 12.

This equilibrium of forces determines threshold values S₁ and S₂. The threshold values S₁ and S₂ result from the geometric design of the pressure valve 110, especially from the areas to which the pressures shown are applied, and from the pressure levels as well as from the tensioning force of the tensioning element 19.

If the pressure outside the receiving-chamber channel 22 drops below the first threshold value S₁, the pressure valve 110 will open through a movement of the first and second pistons 12, 13 in the positive z-direction. If the pressure outside the first pressure-chamber channel 20 exceeds the second threshold value S₂, the pressure valve 110 will close through a movement of the first and second pistons 12, 13 in the negative z-direction.

If the pressure valve 110 is arranged within a container 101, the pressure outside the receiving-chamber channel 22 may correspond to the pressure within the receiving chamber 109 and the pressure outside the first pressure-chamber channel 20 may correspond to the pressure within the pressure chamber 106.

FIG. 7 also shows an insert 23 that can be inserted into the pressure valve body 11. Through the opening in the pressure valve body 11, into which the insert 23 can be introduced, the tensioning element 19 and the second piston 13 can be introduced into the interior of a pressure valve 110 during production of the pressure valve 110. Once the insert 23 has been mounted in the opening of the pressure valve body 11 provided for this purpose, the insert 23 becomes part of the pressure valve body 11.

The pressure valve body 11 may be bipartite (not shown in FIG. 4), in particular such that one of the two projections 28a, 28b is arranged on one part of the bipartite pressure valve body 11 and the other one of the two projections 28a, 28b is arranged on the other part of the bipartite pressure valve body 11. The two parts of the pressure valve body 11 may be connectable e.g. by a screw connection. In the connected condition of the two parts, a bipartite pressure valve body 11 is obtained.

FIG. 8 shows a pressure valve 110 that can be installed in a container 1 on the base side of the latter. The difference to the pressure valve 110 according to FIG. 7 is to be seen in that no gas has been introduced through the pressure valve inlet 24 into the pressure valve 110, so that the first piston 12 is not coupled to the second piston 13.

By introducing a gas via the pressure valve inlet 24, an adjustable pressure p_{V} can be generated in the first pressure valve chamber 15. Likewise, the selection of the type of gas to be introduced into the pressure valve chamber 15 can be adapted to the respective case of use. If the pressure p_{V} in the pressure valve chamber 15 is sufficiently high, the first piston 12 will move in the positive z-direction until it abuts on the second piston 13.

FIGS. 9, 10 and 11 show containers 601, 701 and 801. The containers 601, 701 and 801 may correspond to the above described container 101, so that not all the components of the containers 601, 701 and 801 need to be described in detail. On the basis of the containers 601, 701 and 801, different positions of shut-off units 650, 750 and 850 in pressure valves 610, 710 and 810 of the containers 601, 701 and 801 will primarily be described, the features described being analogously applicable to the container 101, there shut-off unit 550.

The container 601 of FIG. 9 comprises a receiving chamber 609, a filling space 640 and a pressure chamber 606. The filling space 640 is defined by a bag 620a, 620b. The pressure chamber 606 is formed by a container base 602 and a pressure chamber base 605.

In the receiving chamber 609 (and in the filling space 640) a pressure p_{B6} prevails, which lies preferably above the ambient pressure. In the pressure chamber 606 a pressure p_{D6} prevails, which lies preferably above the pressure p_{B6} in the receiving chamber 609.

A pressure valve 610 (e.g. the above described pressure valve 110) is connected to the container base 602 and the pressure chamber base 605.

A shut-off unit 650 is arranged in the pressure valve 610 such that the shut-off unit 650 is positioned in the pressure chamber 606 (in the pressure valve 610). Via a lateral inlet to a first channel in the pressure valve 610, a fluid stored in the pressure chamber 606 under the pressure p_{D6} can penetrate into the pressure valve 610 up to the shut-off unit 650, so that, within the first channel of the pressure valve 610, the pressure p_{D6} will prevail in the pressure chamber 606 up to the shut-off unit 650. On the side of the shut-off unit 650 facing the receiving chamber 609, a second channel extends in the pressure valve 610 up to and into the receiving chamber 609.

If the shut-off unit 650 is closed, a fluid in the pressure chamber 606 cannot flow into the receiving chamber 609. If the shut-off unit 650 is open, a fluid can flow from the pressure chamber 606 through the first and the second channel into the receiving chamber 609.

The container 701 according to FIG. 10 comprises a receiving chamber 709, a filling space 740 and a pressure chamber 706. The filling space 740 is defined by a bag 720a, 720b. In the pressure chamber 706 a pressure p_{D7} prevails and in the receiving chamber 709, and thus in the filling space 740, a pressure p_{B7} prevails, the pressure p_{B7} lying preferably above the ambient pressure.

A pressure valve 710 (e.g. the above described pressure valve 110) is connected to a container base 702 and a pressure chamber base 705 and is thus partly positioned in the pressure chamber 706, since the pressure chamber 706 is formed by the pressure chamber base 705 and the container base 702.

The pressure valve 710 comprises a shut-off unit 750 arranged in a pressure valve section 751, which is located outside the pressure chamber 706. The section 751 of the pressure valve 710 is configured such that it may comprise the shut-off unit 750.

The section 751 of the pressure valve 710 positioned outside the pressure chamber 706 may be configured such that and be in contact with the pressure chamber base 705 such that at least 10% of the area of the pressure chamber base 705 are covered by the section 751. Preferably, at least 15%, more preferred at least 20%, even more preferred at least 25%, in particular at least 30% of the area of the pressure chamber base 705 are covered by section 751 of the pressure valve 710. However, preferably not more than 50%.

The pressure valve 710 comprises a first channel connecting the shut-off unit 750 and the pressure chamber 706, and a second channel connecting the shut-off unit 750 and the receiving chamber 709. If the shut-off unit 750 (and thus the pressure valve 710) is closed, the first and the second channel and consequently the receiving chamber 709 and the pressure chamber 706 are separated from one another in a fluid-tight manner.

The second channel is accessible to a fluid in the pressure chamber 706 through an opening in the pressure chamber base 705.

In FIG. 11, a container 801 comprises a receiving chamber 809, a filling space 840, which is formed by a bag 820a, 820b, and a pressure chamber 806. The pressure chamber 806 is formed by a container base 802 and a pressure chamber base 805.

In the receiving chamber 809 (and in the filling space 840) a pressure p_{B8} prevails, which may lie above the ambient pressure. In the pressure chamber 806 a pressure p_{DB} prevails, which may lie above the pressure p_{B8} in the receiving chamber 809.

A pressure valve 810 of the container 801 is connected to the container base 802 and the pressure chamber base 805.

The pressure valve 810 comprises a first channel connecting the pressure chamber 806 and a shut-off unit 850 of the pressure valve 810, and a second channel connecting the receiving chamber 809 and the shut-off unit 850.

The first channel of the pressure valve 810 is accessible to a fluid in the pressure chamber 806 via an opening in the pressure chamber base 805.

The first channel of the pressure valve 810 leads partially through a section 851 of the pressure valve 810, which is located outside the pressure chamber 806.

The section 851 of the pressure valve 810 located outside the pressure chamber 806 may be configured such that and be in contact with the pressure chamber base 805 such that at least 10% of the area of the pressure chamber base 805 are covered by the section 851. Preferably, at least 15%, more preferred at least 20%, even more preferred at least 25%, in particular at least 30% of the area of the pressure chamber base 805 are covered by section 851 of the pressure valve 810. However, preferably not more than 50%.

The shut-off unit 850 of the pressure valve 810 is arranged such that it is positioned within the pressure chamber 806.

The shut-off unit 650, 750 or 850 may be part of a disk-type shut-off unit comprising a sealing disk and a disk seat.

1. A container for storing a liquid, the container comprising a filling space, a receiving chamber, and a pressure chamber, wherein:
the container comprises a container top, a container wall, a container base and a pressure chamber base;
the pressure chamber is formed by the container base and the pressure chamber base;
the filling space is formed by a bag that is fillable with the liquid, and the bag is arranged in the receiving chamber; and
the bag is fillable with the liquid such that the liquid is in direct contact neither with the container top nor the container wall nor the container base.

2. (canceled)

3. The container according to claim 1, wherein the container comprises an opening at the container top and the opening is closed by a closure.

4. The container according to claim 3, wherein an upper end of the bag is glued to the closure, welded to the closure, or secured to the closure through airtight clamping.

5. The container according to claim 1, wherein the container comprises a pressure valve and the pressure valve is connected to the container base and the pressure chamber base.

6. The container according to claim 5, wherein the pressure valve comprises a shut-off unit, wherein the shut-off unit is arranged in the pressure valve such that the shut-off unit is arranged, at least sectionwise within a volume of the pressure chamber.

7. The container according to claim 5, wherein the pressure valve comprises a shut-off unit, wherein the shut-off unit is arranged in the pressure valve such that the shut-off unit is arranged, at least sectionwise outside the pressure chamber.

8. The container according to claim 5, wherein the pressure valve is in fluid communication with the pressure chamber via an opening in the pressure chamber base, so as to allow a pressurized fluid to enter the pressure valve and to flow therethrough.

9-13. (canceled)

14. The container according to claim 3, wherein the closure has connected thereto a discharge line, whereby the discharge line is connected in a fluid-communicable manner to a filling space line that extends preferably down to the bottom of the bag.

15. The container according to claim 3, wherein the closure comprises a first valve and a second valve.

16. The container according to claim 15, wherein the first valve comprises a first channel, wherein, in the open condition of the first valve, the first channel connects in a fluid-communicating manner the bag and a space surrounding the container.

17. The container according to claim 15, wherein the second valve comprises a second channel, wherein, in the open condition of the second valve, the second channel connects in a fluid-communicating manner the receiving chamber and a space surrounding the container.

18. A container for storing a liquid, comprising a filling space, a receiving chamber and a pressure chamber, wherein:
the container comprises a container top, a container wall, a container base and a pressure chamber base;
the pressure chamber is formed by the container base and the pressure chamber base;
the filling space is formed by a bag that is fillable with the liquid, and the bag is arranged in the receiving chamber; and
an upper end of the bag is associated with an opening in the container top for filling the bag with the liquid.

19-21. (Canceled)

22. A method for filling a container, the container comprising a filling space and a receiving chamber, wherein the filling space is formed by a bag and the bag is arranged in the receiving chamber, the method comprising the steps of:
providing the container; and
filling the bag with the liquid, so that the volume of the bag will increase during the filling process.

23. The method according to claim 22, wherein filling the bag with the liquid is carried out such that the increase in volume of the bag during filling will be compensated for by a flow of content from the receiving chamber into a surroundings of the container.

24. The method according to claim 22, wherein the container comprises an opening that is closed by a closure.

25. The method according to claim 24, wherein the closure comprises a first valve with a first channel through which the bag is filled with the liquid.

26. The method according to claim 25, wherein, when the bag has been filled, the opening of the container is closed by the closure.

27. The method according to claim 24, wherein the closure comprises a first valve with a first channel, through which the bag is filled with the liquid, and the closure comprises a second valve with a second channel, through which at least part of the content flows out of the receiving chamber into a surroundings of the container during the filling process of the bag.

28. The method according to claim 27, wherein the opening of the container is closed by the closure before the bag is filled.

29. The method according to claim 22, wherein the container comprises a closure that closes an opening of the container, and wherein the closure comprises a first valve and a second valve, wherein the second valve connects the receiving chamber to a pressure controller for a limited period of time and the bag is filled via the first valve, the pressure controller allowing an increase in pressure in the receiving chamber up to a threshold value during the filling process.

30. (canceled)

31. (canceled)
